(19) United States
(12) Patent Application Publication
(10) Pub. No.: US 2011/0011371 A1
(43) Pub. Date: Jan. 20, 2011

(54) PUMP UNIT FOR A FUEL INJECTION SYSTEM OF AN INTERNAL COMBUSTION ENGINE

(76) Inventors: Giancarlo Magrone, Molfetta (IT); Nello Medoro, Trinitapoli (Foggia) (IT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/919,865

(22) PCT Filed: Jan. 21, 2009
(86) PCT No.: PCT/EP2009/050611

§ 371 Date: Aug. 27, 2010

(30) Foreign Application Priority Data
Feb. 29, 2008 (IT) MI 2008 A 000340

(51) Int. Cl. F02M 69/00

(52) U.S. Cl. 123/459

(57) ABSTRACT

A pump unit for a fuel injection system of an internal combustion engine is arranged along a fuel feed circuit and has a pre-feed pump and a high-pressure pump which has a pump body and a flange joined to the pump body. The feed circuit is provided with a feed branch and a delivery branch of the pre-feed pump which are formed, at least partly, in the flange of the high-pressure pump.

The present invention relates to a pump unit for a fuel injection system of an internal combustion engine.

In particular, the present invention relates to a pump unit for a fuel injection system of an internal combustion engine, in which the pump unit is arranged along the fuel feed circuit and comprises a high-pressure pump and a pump for pre-feeding the high-pressure pump. The high-pressure pump comprises a pump body and a flange joined to the pump body.

The feed circuit comprises a feed branch and a delivery branch of the pre-feed pump, a fuel tank and a fuel filter. The feed branch connects a tank to the pre-feed pump, while the delivery branch connects the pre-feed pump to the high-pressure pump.

Depending on the requirements and the constructional choices of the various car manufacturing companies, the fuel filter is arranged along the feed branch or along the delivery branch.

When the fuel filter is arranged along the delivery branch, the feed circuit comprises a bypass branch which directly connects the feed branch and the delivery branch so as to bypass the pre-feed pump, and an overpressure valve which is arranged along the bypass circuit so as to allow discharge into the feed branch of any overpressure prevailing along the delivery branch so as to avoid damaging the fuel filter. When the fuel filter is arranged along the feed branch, the pre-feed pump does not require the bypass circuit and the associated overpressure valve. According to the prior art, the delivery branch, the feed branch and the bypass branch, where present, are formed at least partly inside the pre-feed pump.

Consequently, in the large-scale production of pre-feed pumps it is therefore necessary to provide, for each pre-feed pump model with a given delivery and a different pressure, a first pre-feed pump variant suitable for connection to a filter arranged along the delivery branch and to the bypass branch and a second variant suitable for connection to a filter arranged along the feed branch.

In other words, each pre-feed pump model with given delivery characteristics must be manufactured with at least two variants in order to meet the requirements of the various car manufacturing companies.

However, a proliferation of models and variants of models represents for the pre-feed pump manufacturers an increase in the costs for production, storage and distribution of the pre-feed pumps.

The object of the present invention is to provide a pump unit of the type described above able to overcome the drawbacks of the prior art.

According to the invention, this object is achieved by a pump unit for a fuel injection system of an internal combustion engine, in which the pump unit is arranged along the fuel feed circuit and comprises a pre-feed pump and a high-pressure pump which comprises a pump body and a flange joined to the pump body, the feed circuit comprising a feed branch and a delivery branch of the pre-feed pump, the pump unit being characterized in that the feed branch and the delivery branch of the pre-feed pump are formed, at least partly, in the flange of the high-pressure pump.

Since the feed branch and the delivery branch are formed at least partly in the flange, the various variants of the feed circuit may be formed in the flange which, in the case in question, is a less complex component of the pre-feed pump and may be easily produced with different variants for each model of the pump unit, thereby greatly reducing the disadvantages of the prior art.

Further details, characteristic features and advantages of the invention will emerge more clearly from the following description of a non-limiting example of the embodiment provided with reference to the accompanying figures in which:

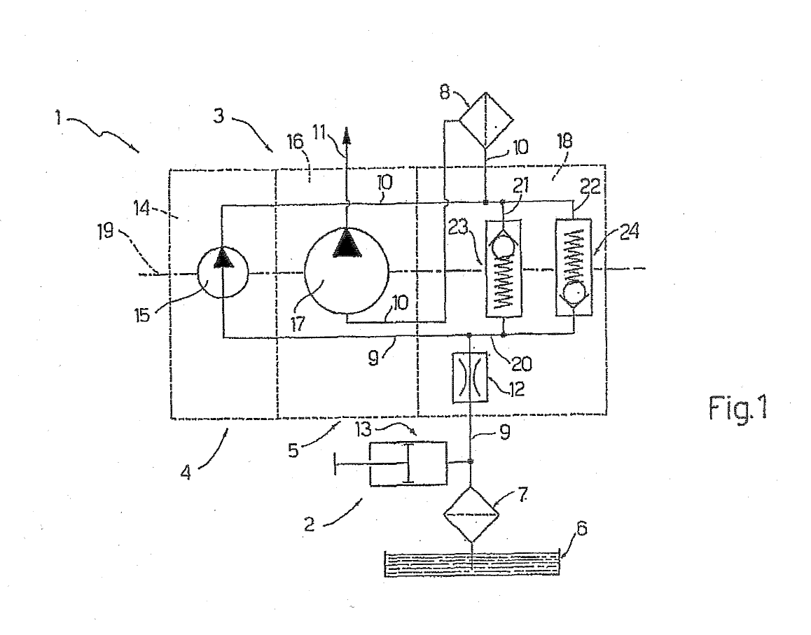

FIG. 1 is a schematic view, with parts removed for the sake of clarity, of a fuel injection system for an internal combustion engine, comprising a pump unit designed according to the present invention; and

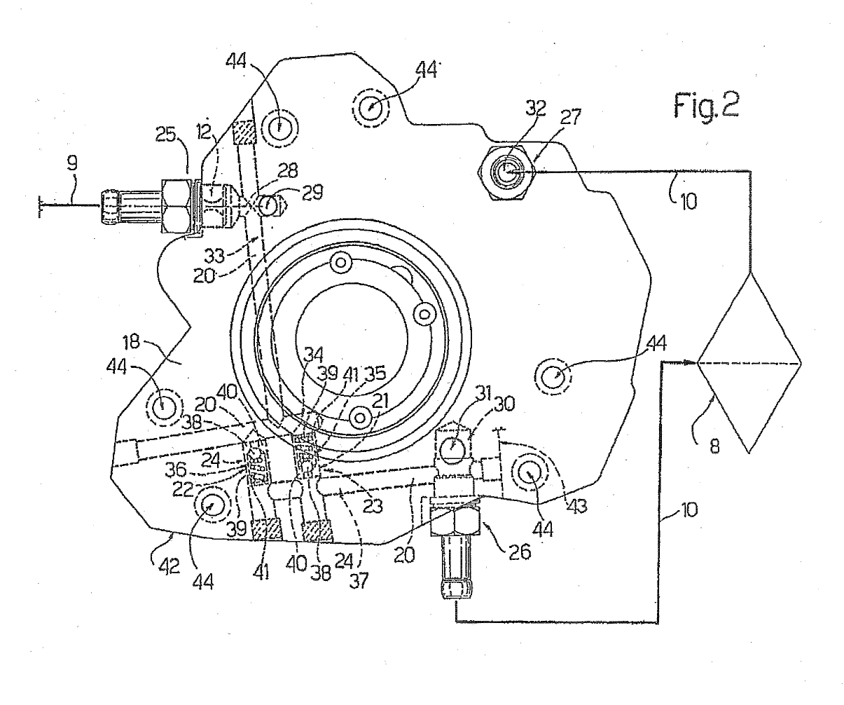

FIG. 2 is a side elevation view, with parts removed for the sake of clarity and on a larger scale, of a detail of the pre-feed pump according to FIG. 1.

It FIG. 1, 1 denotes generally in its entirety a fuel injection system of an internal combustion engine. The injection system 1 comprises a circuit 2 for feeding the fuel to an internal combustion engine (not shown in the accompanying figures) and a pump unit 3 comprising a pre-feed pump 4 and a high-pressure pump 5 for feeding a common rail (not shown in the accompanying figures).

The injection system 1 comprises in succession a tank 6, a pre-filter 7 for separating the water from the intake fuel, the pre-feed pump 4 and the high-pressure pump 5, and a fuel filter 8.

The circuit 2 comprises a feed branch 9 which connects the tank 6 to the pre-feed pump 4 and a delivery branch 10 which connects the pre-feed pump 4 to the high-pressure pump 5. The pre-filter 7 is arranged along the intake branch 9 between the tank 6 and the pre-feed pump 4, while the filter 8 is arranged along the delivery branch 10.

The circuit 2 comprises a high-pressure delivery branch 11 which connects the high-pressure pump 5 to the common rail (not shown in the accompanying figures) and a choke 12 arranged along the feed branch 9 downstream of the pre-filter 7. The feed branch 9 can be connected to a manual pump 13 which has the function of filling the circuit 2 of the injection system 1 with fuel without starting the pre-feed pump 4 and the high-pressure pump 5.

The pre-feed pump 4 comprises a pump body 14 and a pumping station 15 housed inside the pump body 14.

The high-pressure pump 5 comprises a pump body 16, a pumping station 17 housed inside the pump body 16, a flange 18 joined to the pump body 16 and a shaft 19 which is schematically indicated by means of a dot-dash line and has the function of operating the pumping station 17 and the pumping station 15. In fact, the pump body 14 is joined to the pump body 16 on the opposite side of the flange 18.

The circuit 2 comprises a bypass branch 20 which comprises two parallel branches 21 and 22 arranged in parallel and connects the feed branch 9 to the delivery branch 10 and is arranged in the flange 18 in parallel with the pumping station 15, an overpressure valve 23 arranged along the branch 21, and a bypass valve 24 arranged along the branch 22 in parallel with the overpressure valve 23 and the pumping station 15.

The overpressure valve 23 is calibrated so as to discharge, along the feed branch 9, the excess fuel pumped by the pre-feed pump 4, namely when the fuel pressure in the delivery branch 10 exceeds a given value, for example a value in the region of 10 bar.

The bypass valve 24 is calibrated so as to bypass the pumping station 15 when the fuel pressure in the delivery branch 9 assumes a given value during preparation of the injection system 1 for initial use. In fact, before starting a newly constructed internal combustion engine, it is necessary to ensure that all the parts of the internal combustion engine including the component parts of the injection system 1 are filled with fuel, which also has the function of lubricating those parts which, during use, perform an alternating movement. For this purpose, the feed branch 9 is fed by the manual pump 13 which has the function of filling the circuit 2 of the injection system 1 without starting the pre-feed pump 4 and the high-pressure pump 5.

As schematically shown in FIG. 1, part of the feed branch 9, part of the delivery branch 10 and the whole of the bypass branch 20 including the overpressure valve 23 and the bypass valve 24 are arranged in the pump unit 3.

The feed branch 9 and the delivery branch 10 extend along the whole of the pump unit 3 and pass through the flange 18, the pump body 16 and the pump body 14.

The delivery branch 10, after passing through the filter 8, again passes through the flange 18 and the pump body 16 so as to feed the high-pressure pump 5, in particular the pumping station 17.

With reference to FIG. 2, the flange 18 comprises a friction bearing designed to support rotatably the shaft 19 (not shown in FIG. 2), a connector 25 comprising the choke 12 and suitable for connecting the portion of the feed branch 9 outside the flange 18, a connector 26 and a connector 27 for connecting the portion of the delivery branch 10 outside the flange 18. The feed branch 9 extends partly inside the flange 18 along a hole 28 parallel to the plane of the sheet in FIG. 2 and a hole 29 perpendicular to the plane of the sheet in FIG. 2. The delivery branch 10 extends partly inside the flange 18 as far as the connector 26 along a hole 30 parallel to the plane of the sheet in FIG. 2 and along a hole 31 perpendicular to the plane of the sheet in FIG. 2. The holes 30 and 31 are arranged in the vicinity of the connector 26. The delivery branch 10 extends partly inside the flange 18 as far as the connector 27 along a hole 32 perpendicular to the plane of the sheet in FIG. 2. The bypass branch 20 extends entirely inside the flange 18 along holes 33, 34, 35, 36 and 37 which are parallel to the plane of the sheet in FIG. 2.

The hole 28 of the feed branch 9 intersects the hole 33, which intersects the hole 34, which intersect the holes 35 and 36, which in turn intersect the hole 37, which intersects the hole 30 of the delivery branch 10.

The holes 35 and 36 house, respectively, the overpressure valve 23 and the bypass valve 24.

From a constructional point of view, the overpressure valve 23 and the bypass valve 24 are similar and each comprise a shutter 38, a spring 39, a ring 40 provided with a frustoconical seat for supporting the shutter 38, and a ring 41 for supporting the spring 39.

In fact, the bypass valve 24 is an overpressure valve mounted in the opposite direction to the overpressure valve 23.

The holes 28, 30, 33, 34, 35, 36 and 37 are formed by means of drill bits used to bore through lateral surfaces 42 and 43 of the flange 18 and are closed on these lateral surfaces 42 and 43 by means of plugs (not shown in the accompanying figures).

The flange 18 has holes 44 perpendicular to the plane of the sheet in FIG. 1 and used to perform assembly of the flange 18 together with the pump body 16 by means of screws (not shown in the accompanying figures).

The description provided with reference to the accompanying figures clearly highlights the mode of operation and the advantages of the pump unit 3.

Since the feed branch 9 and the delivery branch 10 are arranged, at least partly, in the flange 18, the overpressure valve 23 and the bypass valve 24 may be arranged in the flange 18 in accordance with the requirements of car manufacturing companies and therefore result in a reduction in the number of variants of the pre-feed pump 4.

Consequently, the mass-production of pre-feed pumps 4, storage thereof and distribution to clients are greatly simplified.

Finally, it is evident that the high-pressure pump unit described here may be subject to modifications and variations without departing from the scope of the accompanying claims. For example, the pump unit 1 may be defined solely by the pump body 16 of the high-pressure pump 5 and by the flange 18, while the pre-feed pump 4 is connected to the high-pressure pump 5 by external pipes.

1-11. (canceled)

12. A pump unit for a fuel injection system of an internal combustion engine, the pump unit being arranged along a fuel feed circuit,
the pump unit comprising a pre-feed pump and a high-pressure pump which comprises a pump body and a flange joined to the pump body,
the feed circuit comprising a feed branch and a delivery branch of the pre-feed pump which are formed, at least partly, in the flange of the high-pressure pump.

13. The pump unit according to claim 12, wherein the feed circuit comprises a bypass branch arranged between the feed branch and the delivery branch of the pre-feed pump, the bypass branch being formed in the flange.

14. The pump unit according to claim 12, wherein the feed circuit comprises an overpressure valve arranged along the bypass branch and designed to discharge the fuel exceeding a predetermined pressure from the delivery branch into the feed branch.

15. The pump unit according to claim 13, wherein the feed circuit comprises an overpressure valve arranged along the bypass branch and designed to discharge the fuel exceeding a predetermined pressure from the delivery branch into the feed branch.

16. The pump unit according to claim 14, wherein the overpressure valve is housed in the flange.

17. The pump unit according to claim 15, wherein the overpressure valve is housed in the flange.

18. The pump unit according to claim 12, wherein the feed circuit comprises a bypass valve arranged along the bypass branch in parallel with the overpressure valve and designed to connect directly the feed branch to the delivery branch.

19. The pump unit according to claim 13, wherein the feed circuit comprises a bypass valve arranged along the bypass branch in parallel with the overpressure valve and designed to connect directly the feed branch to the delivery branch.

20. The pump unit according to claim 17, wherein the feed circuit comprises a bypass valve arranged along the bypass branch in parallel with the overpressure valve and designed to connect directly the feed branch to the delivery branch.

21. The pump unit according to claim 18, wherein the bypass valve is housed in the flange.

22. The pump unit according to claim 20, wherein the bypass valve is housed in the flange.

23. The pump unit according to claim 13, wherein the bypass branch extends along a plurality of holes formed in the flange.

24. The pump unit according to claim 14, wherein the bypass branch extends along a plurality of holes formed in the flange.

25. The pump unit according to claim 16, wherein the bypass branch extends along a plurality of holes formed in the flange.

26. The pump unit according to claim 18, wherein the bypass branch extends along a plurality of holes formed in the flange.

27. The pump unit according to claim 21, wherein the bypass branch extends along a plurality of holes formed in the flange.

28. The pump unit according to claim 12, wherein the delivery branch is connected to a fuel filter.

29. The pump unit according to claim 12, wherein the delivery branch is connected to the flange downstream of the fuel filter.

30. The pump unit according to claim 12, wherein the pre-feed pump is joined to the pump body of the high-pressure pump.

31. The pump unit according to claim 12, wherein the pre-feed pump comprises a further pump body, the feed branch and the delivery branch extending partly through the pump body and the further pump body.
